(19) United States
(12) Patent Application Publication
(10) Pub. No.: US 2006/0095946 A1
(43) Pub. Date: May 4, 2006

(54) System and method for broadcasting a video program

(75) Inventor: Laurent Gardes, Boulogne-Billancourt (FR)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/536,850

(22) PCT Filed: Nov. 24, 2003
(86) PCT No.: PCT/IB03/05490

§ 371 Date: May 31, 2005

(30) Foreign Application Priority Data
Dec. 4, 2002 (FR) 0215289

(51) Int. Cl. H04N 7/173

(52) U.S. Cl. 725/97

(57) ABSTRACT

The system for broadcasting a video program to several destinations (14) comprises an assembly of broadcasting sources (26) suitable for ensuring the transmission, on an information transmission network (16), of several video signals comprising the same video program and shifted with respect to time, and means (22) for controlling and managing the broadcasting sources (26). The means (22) for controlling and managing broadcasting sources (26) are adapted to ensure temporal shifts between the video signal supplied by the different sources (26), all of which are proportional to one and the same elementary shift interval (d).

### FIELD OF THE INVENTION

The invention relates to a system and a method for broadcasting a video program.

Such a system enables a user having a receiver to have a video program at his disposal which he may start viewing when he so wishes or temporarily stop and subsequently resume viewing as from the instant when the program was stopped previously.

Such methods and broadcasting systems are known and are capable of supplying a video-on-demand service (VOD).

### BACKGROUND OF THE INVENTION

A broadcasting system supplying video programs on demand is notably described in U.S. Pat. No. 5,771,437.

The broadcasting system described in this document is adapted to receive requests from users wishing to view a program and to broadcast, to the requesting user, a video signal starting at the instant of receiving the request. However, to limit the passband which would be necessary to meet a very large number of requests, the number of broadcasts concomitant with a slight shift of the video signal is taken into account and this number of broadcasts has a ceiling at a maximum number. If this maximum number of broadcasts is reached and a new user requests the initiation of a new broadcast assignment, this assignment is refused and a video signal having a start proximate to the instant of request is addressed to him only.

With such a system of broadcasting video programs, the access to the program may be extra long in the case where the maximum number of simultaneously broadcast video signals is reached. In practice, the delay may thus be as much as fifteen or twenty minutes as a function of the conditions.

### OBJECT AND SUMMARY OF THE INVENTION

It is an object of the invention to propose a system of broadcasting a video program using, for the transmission, only one limited passband and yet allowing rapid access to a video signal irrespective of the instant of request by the user and irrespective of the number of users posing the request.

To this end, the invention provides a system for broadcasting video programs to several destinations, and is characterized in that it comprises an assembly of broadcasting sources suitable for ensuring the transmission, on an information transmission network, of several video signals comprising the same video program and shifted with respect to time, and means for controlling and managing broadcasting sources, and in that the means for controlling and managing the broadcasting sources are adapted to ensure temporal shifts between the video signals supplied by the different sources, all of which are proportional to one and the same elementary shift interval.

In accordance with a particular embodiment, the broadcasting system has one or several of the following characteristic features:
said elementary shift interval is between 1 and 60 seconds;
the controlling and managing means comprise means for receiving a request for a video signal as from a given position and the controlling and managing means are adapted to control a broadcasting source for broadcasting the video signal as from the given position only in the case of receiving a request for said video signals as from the given position;
each broadcasting source comprises an address on the information transmission network allowing, at a destination, the connection to the broadcasting source and the reception of the video signal broadcast thereby, and the controlling and managing means comprise means for receiving a request for a video signal as from a given position and means for addressing, to the requesting destination, the address on the network of the broadcasting source ensuring the broadcast of the video signal as from the given position; and
it comprises at least one destination comprising means for memorizing a position in the video signal during reception of a first video signal, and means for subsequently receiving a second video signal shifted temporally with respect to the first video signal as from the memorized position.

The invention uses a system for broadcasting a video program as defined hereinbefore for broadcasting the same program to several destinations connected to an information transmission network.

The invention further provides a method of broadcasting a video program to several destinations, and is characterized in that it comprises a step of transmitting, on an information transmission network, several video signals having identical contents from an assembly of broadcasting sources, which video signals are shifted in time with temporal shifts between the video signals supplied by the different sources, all of which are proportional to one and the same elementary shift interval.

### BRIEF DESCRIPTION OF THE DRAWINGS

The invention will be better understood by reading the following description solely given by way of example and with reference to the drawings, in which:

FIG. 1 is a diagram of an installation for broadcasting video programs, incorporating a broadcasting system according to the invention;

FIG. 2 is a graph illustrating the planning of the broadcast of one and the same video signal;

FIG. 3 is a flow chart of the method used by the broadcasting system according to the invention;

FIG. 4 is a diagram illustrating the data streams between the different installation units at different stages of the method according to the invention; and

FIG. 5 is a view identical to that of FIG. 2 and illustrates the operation of the system for broadcasting video programs in another situation.

### DESCRIPTION OF EMBODIMENTS

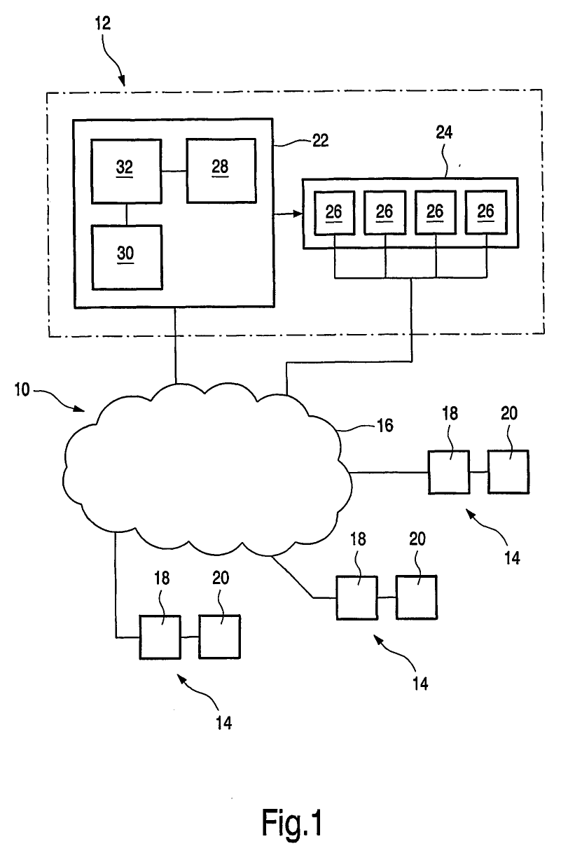

FIG. 1 shows an installation for broadcasting and receiving video programs. This installation comprises a broadcasting system 12 connected to an assembly of receiving stations 14 put at the disposal of users. Each station 14 is connected to a system 12 for broadcasting video programs by an information transmission network 16 such as the Internet.

The number of receiving stations is, for example, several tens or hundreds or thousands. Each receiving station is at the disposal of a home or center.

Each receiving station 14 is constituted, for example, by a digital decoder 18 and a display screen 20 connected to the decoder. The screen 20 is part of, for example, a television.

The decoder 18 comprises an interface for connection to the network 16. It is notably adapted to address, to the broadcasting system 12, requests via the network 16 and to receive, from this system, a video signal corresponding to the requested video program.

As is known per se, the decoder 18 also comprises means for forming the video signal received from the broadcasting system 12 into a signal which can be processed by the television 20.

The broadcasting system 12 comprises a controlling and managing server 22 connected to the network 16. It also comprises a broadcasting bay 24 constituted by several broadcasting sources 26, each connected directly or indirectly to the network 16. These broadcasting sources, in a number of N, are suitable for broadcasting one and the same video signal, which video signals have a time overlap with a predetermined temporal shift.

The broadcasting bay 24 is constituted, for example, by one or several servers connected to the network 16.

Each broadcasting source 26 comprises a universal address suitable for the Internet. This address is known as IP address. The connection to a broadcasting source from each station 14 is possible from this address IP by using the Internet protocol in the conventional manner.

Each broadcasting source 26 is controlled by the controlling and managing server 22 for starting and stopping them.

The sources are adapted to start the transmission of the video signal either from its start or from a determined position p of this signal.

To this end, the controlling and managing server 22 comprises means 28 for controlling sources 26 allowing the broadcast of the video signal to start or stop at a given position.

The controlling and managing server 22 comprises means 30 adapted to receive, from each station 14, a request for receiving the video signal as from a given position p. These means are also adapted to address, to the station having sent the request, the IP address of a broadcasting source 26 to which the station must be connected in order to receive the video signal.

The controlling and managing server 22 also comprises processing means 32 ensuring the control of the means 28 and 30 by using the method whose algorithm will be described hereinafter.

The server 22 also comprises a clock for synchronizing a complete installation. This clock is suitable for defining a rhythm signal formed by a regular succession of starting instants tᵢ, all of which are temporally separated by the same shift interval denoted δ.

Finally, each decoder 18 comprises means for automatic connection to a broadcasting source 26 whose IP address has been communicated by the controlling and managing server 22 after a request for connection has been sent to this server.

In a general manner, the system 12 for broadcasting video programs is adapted to control the broadcasting sources 26 under the control of the controlling and managing server 22, so as to broadcast the same video signal corresponding to a video program with temporal shifts between the video signals, all of which are proportional to one and the same elementary shift interval δ.

This elementary shift interval δ is a sub-multiple of the total duration of the video program denoted T. This interval δ is between 1 and 60 seconds and preferably between 3 and 20 seconds.

For example, if the video program lasts T=100 minutes, i.e. 6000 seconds, 600 broadcasting sources 26 are used so that the elementary shift interval δ=T/N is equal to 10 seconds.

At a given instant, only certain broadcasting sources 26 are active, or all the broadcasting sources are active.

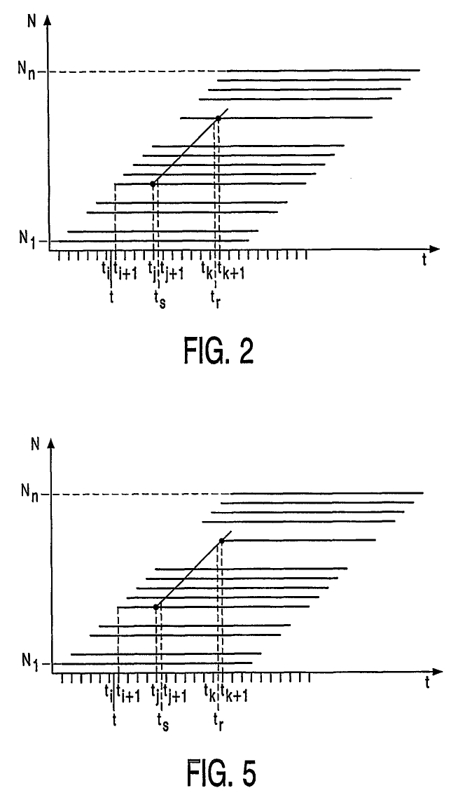

FIG. 2 illustrates diagrammatically, for an assembly of broadcasting sources 26, the initial and final broadcasting instants for each source denoted N₁ to Nₙ. The broadcasting of the video signal is represented by a horizontal solid line.

The video signals succeed each other for one and the same broadcasting source 26, so that two identical or non-identical video signals are broadcast successively from the same source.

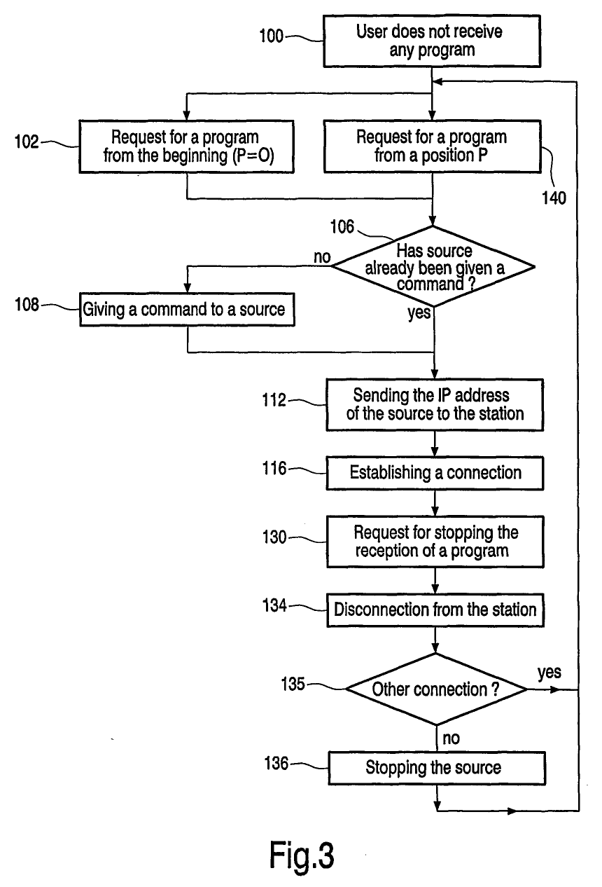

The algorithm used by the broadcasting system 12 will now be described with reference to FIGS. 2, 3 and 4.

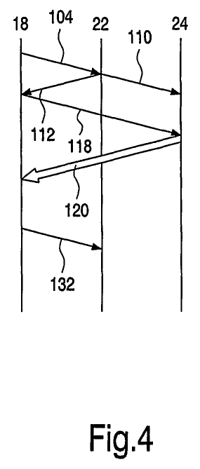

Initially, it is supposed that a user having a receiving station 14 at his disposal does not receive any program in step 100. If this user wants to receive a program from the beginning, the associated decoder 18 addresses, in step 102, a request 104 to the controlling and managing server 22 (FIG. 4) with the object of requesting the immediate reception of a video program from the beginning. The request is supposed to be received by the server 22 at the instant t between the starting instants tᵢ and tᵢ₊₁, as illustrated in FIG. 2.

In step 106, the processing means 32 of the controlling and managing server determine whether a broadcasting server 26 has been given the command to start the transmission of the video signal at the next starting instant tᵢ₊₁ fixed by the rhythm clock of the server.

If this is not the case, the server 22 gives the command, in step 108, to a broadcasting source 26 to start, at the next starting instant tᵢ₊₁, the transmission of the video signal at the requested position p, i.e. at the initial position in this case.

To this end, a command 110 is addressed from the server 22 to the broadcasting source 26.

In all cases, at the start of step 106 or 108, the controlling and managing server 22 sends, in step 112, the IP address of the source 26 to the decoder of the requesting station, which address is suitable for supplying the video signal requested in a message 112.

In step 116, the decoder 18 of the station which has made the request establishes a connection with the source 26 by means of a connection request 118. The decoder 18 then receives from the starting instant tᵢ₊₁ the video signal as from the desired position of the defined source, namely the initial instant in this case.

When the user wants to have a break, at the instant tₛ, in the video program he is watching, the decoder 18 addresses, in step 130, a request 132 (FIG. 4) to the server 22, which request indicates that the broadcast of the video signal to its destination is no longer necessary.

The decoder 18 is disconnected from the broadcasting source in step 134. Simultaneously, the decoder 18 memorizes the position p of the video signal corresponding to the starting instant t₁ immediately before the instant tₛ at which the break was commanded, as is illustrated in FIG. 2.

The controlling and managing server 22 determines, in step 135, whether other users are connected to the broadcasting source. If this is the case, the transmission from this broadcasting source is maintained. In contrast, if no user is connected to this broadcasting source, this source is stopped in step 136.

If, in step 140, the user having stopped reception of a video program wishes, at the instant tᵣ illustrated in FIG. 2, to resume watching the program as from the memorized position p, the decoder 18 addresses, in step 140, a request 104 for re-establishing a connection to receive the video signal as from the position p. Step 106 is then used again.

The instant tᵣ is supposed to be between the starting instants tₖ and tₖ₊₁. In step 106, the server 22 determines whether one of the sources has already been commanded to transmit, at the next starting instant tₖ₊₁, the video signal as from its position p. The signal may be a signal which has already been transmitted from the beginning or a signal whose transmission has been requested as from the instant tₖ₊₁ only. If this is the case, the server 22 sends, in step 112, the IP address of the source 26 to the decoder 18 with a view to its connection.

In contrast, if no source has been commanded, the server 22 commands a source 26 to initiate the transmission of the signal at the instant tₖ₊₁ a by starting at the position p, as is illustrated in FIG. 5.

The IP address of the source 26 is then sent to the decoder 18.

In both cases, the decoder establishes a connection with the source, in step 116, and thus receives the video signal.

It will be understood that with such a method, the maximum number of simultaneous transmissions of the video signal is limited, thus reducing the passband which is necessary to satisfy each user. Moreover, as the video signals are shifted with respect to time in that they are regularly partitioned, the average waiting time for the users is very much reduced and is maximally equal to the shift interval between two video signals. Consequently, with the maximum waiting time being short, the shift which may exist between the instant of request by the user and the instant of meeting this request is quasi-imperceptible.

1. A system for broadcasting a video program to several destinations, characterized in that it comprises an assembly of broadcasting sources suitable for ensuring the transmission, on an information transmission network, of several video signals comprising the same video program and shifted with respect to time, and means for controlling and managing broadcasting sources, and in that the means for controlling and managing the broadcasting sources are adapted to ensure temporal shifts between the video signals supplied by the different sources, all of which are proportional to one and the same elementary shift interval.

2. A broadcasting system as claimed in claim 1, characterized in that said elementary shift interval is between 1 and 60 seconds.

3. A broadcasting system as claimed in claim 1, characterized in that the controlling and managing means comprise means for receiving a request for a video signal as from a given position and the controlling and managing means are adapted to control a broadcasting source for broadcasting the video signal as from the given position only in the case of receiving a request for said video signals as from the given position.

4. A broadcasting system as claimed in claim 1, characterized in that each broadcasting source comprises an address on the information transmission network allowing, at a destination, the connection to the broadcasting source and the reception of the video signal broadcast thereby, and in that the controlling and managing means comprise means for receiving a request for a video signal as from a given position and means for addressing, to the requesting destination, the address on the network of the broadcasting source ensuring the broadcast of the video signal as from the given position.

5. A broadcasting system as claimed in claim 1, characterized in that it comprises at least one destination comprising means for memorizing a position in the video signal during reception of a first video signal, and means for subsequently receiving a second video signal shifted temporally with respect to the first video signal as from the memorized position.

6. A receiver for receiving a video signal from the broadcasting sources of a system as claimed in claim 1, the receiver comprising means for memorizing a position in the video signal during reception of a first video signal, and means for subsequently receiving a second video signal shifted temporally with respect to the first video signal as from the memorized position.

7. Use of a system for broadcasting a video program as claimed in claim 1, for broadcasting the same program to several destinations connected to an information transmission network.

8. A method of broadcasting a video program to several destinations, characterized in that it comprises a step of transmitting, on an information transmission network, several video signals having identical contents from an assembly of broadcasting sources, which video signals are shifted in time with temporal shifts between the video signals supplied by the different sources, all of which are proportional to one and the same elementary shift interval.
